(19) United States
(12) Patent Application Publication
(10) Pub. No.: US 2007/0200323 A1
(43) Pub. Date: Aug. 30, 2007

(54) Vehicle Occupant Protection System for a Motor Vehicle

(75) Inventors: Frank Bertele, Dettenhausen (DE); Ralf Bogenrieder, Stuttgart (DE); Xavier Christmann, Stuttgart (DE); Christoph Kern, Weil der Stadt (DE); Dominic Reutter, Birenbach (DE); Florian Zenker, Stuttgart-Feuerbach (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/592,941

(22) PCT Filed: Mar. 9, 2005
(86) PCT No.: PCT/EP05/02465

§ 371 Date: Feb. 26, 2007

(30) Foreign Application Priority Data
Mar. 16, 2004 (DE) 10 2004 012 880.4

(51) Int. Cl. B60R 21/207; B60R 21/0134

(52) U.S. Cl. 280/730.2; 280/730.1; 280/735

(57) ABSTRACT

The invention relates to a vehicle occupant protection system for a motor vehicle having a vehicle seat with airbags which are integrated into lateral areas of a seating part and of a backrest, the air pressure of the airbags being adjustable by means of a compressed air regulating device. According to the invention, a coordination system is provided which evaluates the data which is relevant to the safety of the driving operation, and times the actuation of the compressed air regulating device in such a way that at least one airbag of the vehicle seat is inflated before the occurrence of an anticipated accident.

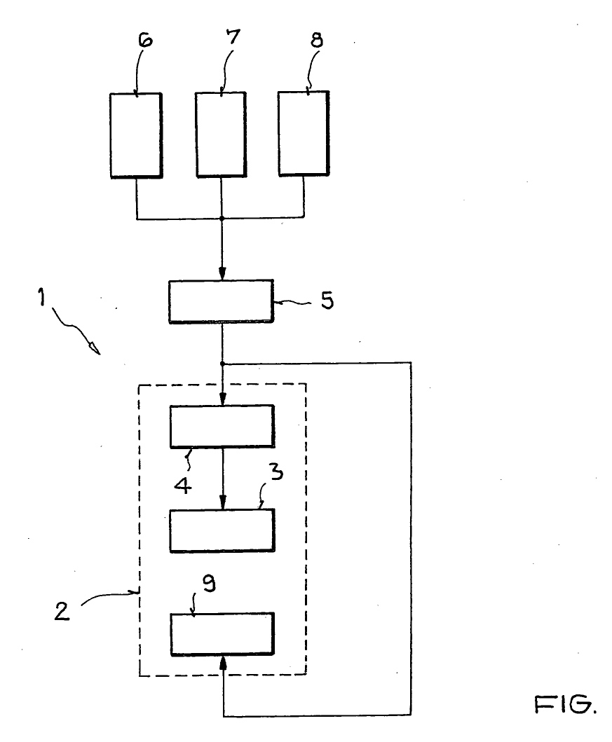

This application is a National Phase of PCT/EP2005/002465, filed Mar. 9, 2005, and claims the priority of DE 10 2004 012 880.4, filed Mar. 16, 2004, the disclosures of which are expressly incorporated by reference herein.

### BACKGROUND AND SUMMARY OF THE INVENTION

The present invention relates to a vehicle occupant protection system for a motor vehicle having a vehicle seat with airbags that are integrated into lateral areas of a seating part and of a backrest.

DE 100 22 434 A1 discloses a vehicle seat having an adaptation system for adapting a lateral support of a sitting person in a vehicle seat in terms of vehicle movement dynamics. The adaptation system has airbags that are integrated into lateral areas of a seating part and of a backrest, and a compressed air regulating device for adjusting the air pressure in the airbags. A control unit is connected to the compressed air regulating device and generates, from a lateral acceleration value fed to it, a control signal for adjusting an inflation pressure by way of the compressed air regulating device. A device is provided for predicting the lateral acceleration to be anticipated in a current bend. The predicted lateral acceleration is made available to the control unit while taking into account the inflation-pressure-dependent inflation times of the adaptation system.

DE 199 27 403 A1 describes a backrest for a vehicle seat with a headrest, backrest cushion element and a support element for the back of a seated person. In the event of a rear-end collision, the support element is resilient in the upper backrest area so that the back of the seated person can move rearwards relative to the headrest. The support element is formed by a shaped cushion that is integrated into the backrest cushion element in the upper backrest area, is inflated with a gaseous medium and empties suddenly in the event of a rear-end collision.

Furthermore, DE 101 21 386 C1 discloses a method for actuating a reversible vehicle occupant protection system in a motor vehicle with a sensor system that senses driving state data. Monitored driving state data comprises emergency braking operations, oversteering and understeering of the motor vehicle. The vehicle occupant protection system is triggered as a function of such a state. In addition, the direction from which a maximum hazard is to be anticipated is determined from the driving state data. The vehicle occupant protection system is actuated so that the protective effect is provided in accordance with the direction of maximum hazard.

Furthermore, DE 44 11 184 C2 describes a restraint belt system for a seat in a vehicle having a seatbelt and a seatbelt pretensioner for securing a passenger on the seat. A device can determine the distance from an object and the corresponding relative speed. The anticipated time to the possible collision between the vehicle and the object are determined from this. A control unit generates a control signal that increases the force of the seatbelt pretensioner in good time before the possible collision. If a collision can be avoided, the force of the seatbelt pretensioner is reduced again. The controllable seatbelt pretensioner is a pretensioning device which is active only up to a predefined pretension before the collision, a further seatbelt pretensioner being triggered to pull on the seatbelt more tautly when the collision is actually detected.

An object of the present invention is to provide a vehicle occupant protection system for a motor vehicle having a vehicle seat with airbags that are integrated into side areas of a seating part and of a backrest and that ensures a protective effect for a vehicle occupant which is optimized compared to the prior art.

The aforesaid object has been achieved by way of a vehicle occupant protection system for a motor vehicle having a vehicle seat with airbags that are integrated into side areas of a seating part and of a backrest, which evaluate data that is relevant to safety of the driving operation, and to time actuation of the compressed air regulating device so that at least one airbag is inflated before an anticipated accident.

According to the invention, a control unit evaluates the data that is relevant to the safety of the driving operation and times the actuation of the compressed air regulating device so that at least one airbag of the vehicle seat is inflated before the occurrence of an anticipated accident. The vehicle occupant protection system for the motor vehicle having the vehicle seat comprises the airbags which are integrated into side areas of the seating part and of the backrest, the air pressure of the airbags being adjustable by means of the compressed air regulating device. The air cushions of the vehicle seat are used by the vehicle occupant protection system to protect the vehicle occupant in a driving situation which is critical in terms of safety.

The vehicle occupant is provided, via the airbags, with a stable, predefined and secured position on the vehicle seat. It is advantageous if the airbags are already inflated before the occurrence of the anticipated accident. When the actual accident occurs, the vehicle occupant already assumes the optimized sitting position. As a result, the time immediately before the accident is already utilized to initiate preventative measures for improving the safety of the vehicle occupants. The preventatively acting vehicle occupant protection system thus ensures preventative vehicle occupant protection. More wide ranging protection measures can be used more effectively owing to the optimized sitting position. For example, triggering of an airbag when the accident occurs can be matched directly to the predefined sitting position because the vehicle occupant no longer assumes a sitting position which deviates from this predefined sitting position.

In one embodiment of the invention, all the airbags of the motor vehicle or only those air cushions of the vehicle seat that are relevant in terms of safety equipment for the specific accident are inflated in good time before the anticipated accident. Depending on the accident, for example due to the action of external forces on the motor vehicle from different directions, it may already be sufficient for only specific airbags that are arranged in the vehicle seat to be activated. However, all the airbags of the vehicle seat that are present can be triggered, as a result of which the evaluation process of the data that is relevant to safety in the control unit can be simplified.

It is advantageous if at least one support element in the backrest and/or a headrest has correspondingly shaped airbags are inflated in good time before the anticipated accident. The vehicle seat can be provided with further airbags with different dimensions, as a result of which the vehicle occupant protection is additionally increased.

In particular, the adjustment of the air pressure of the airbag by way of the compressed air regulating device can be carried out as a function of a vehicle occupant classification and/or a person identification. A vehicle occupant classification can be carried out, for example, by the body weight or the size of the vehicle occupant. A person identification can be carried out, for example, by a person-related use authorization system, such as a key or a keyless go card, or by eye recognition, speech recognition and fingerprint recognition. It is also contemplated to evaluate motor-vehicle-related variables. Since, for example, in order to bring about a restraining effect of large and heavy vehicle occupants by the air cushions, a different air pressure is required for the air cushions than for small and lightweight vehicle occupants, the air pressure that is most suitable for the safety of the respective vehicle occupant can be set by the vehicle occupant classification system and/or the person identification system in order to optimize the seat.

In a further embodiment, the data that is relevant to the safety of the driving operation comprises driving state variables, ambient data and/or driver activities of the driver of the motor vehicle. Driving state variables are understood to be variables such as speed of the vehicle, yaw accelerations, longitudinal accelerations and lateral accelerations, brake pedal position, driving pedal position, steering angle, the status of operator control elements such as flashing indicator lights and flashing warning lights as well as the status of sensors and control units which relate to the motor vehicle. Ambient data refers to data which is made available by ambient sensors, telematics systems and by communication between the motor vehicle and other motor vehicles and stationary communication systems. Examples of ambient data are information on the respective location, on the category of road and the lane on which the driver's own motor vehicle is traveling. Further ambient data comprises, inter alia, the state of the road, the temperature, the weather conditions, the light conditions and the velocity, distance, type and size of motor vehicles traveling ahead, adjacent motor vehicles, motor vehicles following behind or oncoming motor vehicles and of other road users. Sensing the driver activity comprises, for example, detecting eye movement, viewing direction and also the operator control processes of operator control elements such as, for example, the steering wheel, gear selector lever and brake pedal. By evaluating a multiplicity of data items that are relevant to safety the correct time for the triggering of the airbags can be determined where necessary.

Other objects, advantages and novel features of the present invention will become apparent from the following detailed description of the invention when considered in conjunction with the accompanying drawings.

### BRIEF DESCRIPTION OF THE DRAWINGS

The single FIGURE is a schematic circuit diagram showing a detail of a vehicle occupant protection system for a motor vehicle with a vehicle seat.

### DETAILED DESCRIPTION OF THE DRAWINGS

A vehicle occupant protection system 1 for a motor vehicle having a vehicle seat 2 comprises airbags 3 that are arranged in the vehicle seat 2. The air pressure of the airbags 3 is adjusted by a compressed air regulating device 4.

A control unit 5 evaluates the data 6 that is relevant to the safety of a driving operation with respect to a possible imminent accident. The data 6 relevant to the safety of a driving operation may be driving state variables, ambient data and/or evaluated driver activities. An accident includes not only collisions but also other situations that are critical to driving such as, for example, extreme skidding on an icy carriageway. If the evaluation of the data 6 that is relevant to safety has a result which is critical in terms of safety, the actuation of the compressed air regulating device 4 is timed, in order to inflate the airbags 3, so that the airbags 3 of the vehicle seat 2 are inflated before the actual occurrence of an anticipated accident.

The airbags 3 are integrated into side areas of a seating part and of a backrest of the vehicle seat 2. In addition, support elements in the backrest and/or a headrest can have correspondingly shaped airbags 3 that are actuated by the compressed air regulating device 4 and inflated in good time before the occurrence of the anticipated accident.

When the vehicle occupant protection system 1 is operating, all the airbags 3 of the vehicle seat 2 can be inflated simultaneously. In a further operating mode of the vehicle occupant protection system 1 it is contemplated to inflate only those airbags 3 of the vehicle seat 2 that are relevant in terms of the safety equipment for the specific accident. If a low hazard potential is present for the vehicle occupant, it may be sufficient to inflate just one or two airbags 3. The air pressures of the respective airbags 3 can also be adjusted by the compressed air regulating device 4 as a function of the specific accident.

In addition or as an alternative, the air pressure can be adjusted by the compressed air regulating device 4 as a function of vehicle occupant classification 7 and/or person identification 8. This ensures a person-specific, individual adjustment of the air pressure, and also improves the safety for the vehicle occupant. If the accident does not occur, the air cushions 3 of the vehicle seat 2 are deflated.

Furthermore, the control unit 5 can actuate a reversible seatbelt pretensioner 9 and activate it in good time before the anticipated accident. The reversible seatbelt pretensioner 9 is adjusted with adaptation to the sitting position of the vehicle occupant which under certain circumstances will have changed as a result of the airbags 3.

The inventive vehicle occupant protection system 1 for the motor vehicle provides the vehicle occupant with a preventative vehicle occupant protection that ensures significantly improved vehicle occupant protection compared to the prior art. The vehicle occupant is stabilized by the airbags 3 in an optimum sitting position in terms of safety equipment and the vehicle occupant is prevented from undesirably slipping out of the vehicle seat 2. Protection systems which are already present in the motor vehicle are supplemented by the use of these preventative safety measures.

1-9. (canceled)

10. A vehicle occupant protection system for a motor vehicle having a vehicle seat with airbags integrated into lateral areas of a seating part and of a backrest, a compressed air regulating device configured to adjust air pressure of the airbags, and a control unit configured to evaluate data that is relevant to safety of the driving operation, and to time the actuation of the compressed air regulating device so that at least one airbag is inflated before an anticipated accident.

11. The vehicle occupant protection system as claimed in claim 10, wherein all the airbags are inflated before the anticipated accident.

12. The vehicle occupant protection system as claimed in claim 10, wherein only the airbags that are relevant in terms of safety equipment for a specific accident are inflated.

13. The vehicle occupant protection system as claimed in claim 10, wherein at least one support element in at least one of the backrest and a headrest has airbags actuated by the compressed air regulating device.

14. The vehicle occupant protection system as claimed in claim 10, wherein the air pressure is set by the compressed air regulating device as a function of at least one of a vehicle occupant classification system and a person identification system.

15. The vehicle occupant protection system as claimed in claim 10, wherein the air pressure is set by the compressed air regulating device as a function of a specific accident.

16. The vehicle occupant protection system as claimed in claim 10, wherein the data comprises at least one of vehicle state variables, ambient data and driver activities.

17. The vehicle occupant protection system as claimed in claim 10, wherein the airbag is arranged to be deflated if an accident does not occur.

18. The vehicle occupant protection system as claimed in claim 10, wherein the control unit is configured to actuate a reversible seat belt pretensioner in a time sufficiently before the anticipated accident.
